(19) United States
(12) Patent Application Publication
(10) Pub. No.: US 2019/0178453 A1
(43) Pub. Date: Jun. 13, 2019

(54) LED APPARATUS

(71) Applicant: XIAMEN ECO LIGHTING CO. LTD., Xiamen (CN)

(72) Inventors: Maojin Zeng, Xiamen (CN); Qiqing Yu, Xiamen (CN); Zhenkun Huang, Xiamen (CN)

(21) Appl. No.: 16/216,586

(22) Filed: Dec. 11, 2018

(30) Foreign Application Priority Data
Dec. 11, 2017 (CN) 201721717203.8

(51) Int. Cl. F21S 8/02; F21V 15/01; F21V 17/16; F21V 23/00; F21V 29/503; F21V 17/10; F21V 3/02; F21V 29/70

(52) U.S. Cl. CPC F21S 8/026; F21V 15/01; F21V 17/164; F21V 23/009; F21Y 2115/10; F21V 17/10; F21V 3/02; F21V 23/002; F21V 29/70; F21V 29/503

(57) ABSTRACT

A downlight apparatus has a main housing, a light source plate, two elastic wings, a driver circuit, a driver box. The driver box contains the driver circuit and has two first positioning devices. The back cover is disposed with two second positioning devices corresponding to the first positioning devices. The driver circuit does not occupy whole space of the driver box.

### FIELD

The present invention is related to a LED apparatus and more particularly related to a LED downlight apparatus.

### BACKGROUND

It is popular now to use LED technology in various light apparatuses. Downlight devices are widely seen in office and home environments. Since the use of downlight devices are so popular, any advancement brings great benefit to further improve the development of the industry and human life.

### SUMMARY OF INVENTION

In some embodiments, a downlight apparatus is designed to be fixed to an installation cavity of a ceiling.

The downlight apparatus includes a main housing, a light source plate, two elastic wings, a driver circuit and a driver box.

The main housing has a back cover, a container and a light opening. The light source plate may be mounted with multiple LED chips. The light source plate is attached to a bottom side of the back cover of the main housing.

The light may be emitted directly toward the light opening. Alternatively, a light guide may be used for guiding LED light sources to the light opening via the light guide.

The light source plate may be a circulate plate shape directly attached to a bottom side of the back cover. Alternatively, the light source plate may be a circular belt surrounding a light guide as mentioned above.

In some embodiments, the light opening may be covered by a lens or a diffusion cover.

In different areas, the ceiling may be opened or reserved with an installation cavity, e.g. with a reserved hole in a ceiling or an installation box disposed in the ceiling.

To fix the downlight apparatus to the ceiling, the two or more elastic wings have first ends fixed to the main housing while second ends for engaging the installation cavity. Specifically, the elastic wing may be made of a spring that may be deformed, reshaped or rotated elastically so as to enter the installation cavity. After the downlight apparatus enters the installation cavity, the elastic wings may be expanded back to original shape to hold the downlight apparatus staying in the installation cavity, instead of falling down.

The driver circuit is used for converting an external power source to a driving current supplying to the light source plate for generating light transmitting outside the light opening. A wireless circuit and corresponding processor circuit for connecting with an external device like a mobile phone may also be disposed in the driver circuit for transmitting commands and/or transmitting status of the downlight apparatus.

The driver box may be made of metal material. The driver box contains the driver circuit. The metal material may be used for heat dissipation and safety, e.g. to prevent further damage during fire accident.

The driver box may have at least one first positioning device. The driver box has a containing space. The driver circuit may occupy less than 70% of the containing space. Specifically, there is a certain amount of space reserved in the driver box, even the driver circuit is installed in the driver box.

Such design may help heat dissipation, and may increase safety of the downlight apparatus. Some reservation holes may be used for connecting wires connecting to an external power source or the light source plate of the downlight apparatus.

There may also be at least one second positioning device disposed on a top side of the back cover. The second positioning device may be a part component of the back cover, e.g. formed at the same shaping process while manufacturing the back cover or as a separate component fixed to the back cover. The second positioning device is corresponding to the first positioning device. Specifically, if there are two first positioning devices, there are two corresponding second positioning devices. The first positioning device is positioned, e.g. aligned or confined by, and attached to the second positioning device for fixing the driver box to the back cover.

In some embodiments, there are two first positioning devices arranged on two opposite sides of the driver box. Furthermore, the two first positioning devices may respectively have two positioning holes. There are two second positioning devices as two vertical bars passing through the two positioning holes respectively.

In such case, two vertical bars extends from the back cover upwardly facing to corresponding positioning holes. The driver box is plugged and attached to the back cover of the main housing.

With such alignment, it is easy to assembly the downlight apparatus. Furthermore, it is also convenient to connect related wires for making the downlight apparatus working normally.

In some embodiments, the two vertical bars engage lateral surfaces of the driver box after passing through the two positioning holes. In such design, the vertical bars may help transmit heat for enhance overall heat dissipation of the downlight apparatus.

In some embodiments, the two vertical bars may carry heat of the light source plate to the lateral surfaces of the driver box.

The two vertical bars may also increase rigidity and structure strength of the downlight apparatus. For example, the main housing may be made of plastic, and the two vertical bars grab the metal driver box. The driver box enhance the structure strength of the plastic main housing.

In some embodiments, the two vertical bars are two elongated strips. In some embodiments, the front end of the two elongated strips may be rounded or processed with a chamfer for preventing hurting people and for enhancing assembly of the downlight apparatus.

In some embodiments, the two elongated strips are connected by a horizontal part, the horizontal part is fixed on the top side of the back cover. For example, the two elongated strips and the horizontal part together form a U shape structure facing upwardly. The length of the horizontal part corresponds to a width of the driver box so that the driver box may be fit between the inner shape of the two elongated strips and the horizontal part.

In some embodiments, the two elongated strips and the horizontal part are different parts of an uni-body metal component. Specifically, the two elongated strips and the horizontal part are made in the same process, e.g. by bending two opposite ends with 90 degrees facing upwardly by applying the force to an elongated metal strip.

In some embodiments, the driver box further has two tracks disposed on the lateral surfaces for inserting the two vertical bars. Specifically, in addition to the two positioning holes, the driver box further has two tracks corresponding to the two elongated strips passing through the positioning holes. With such track, the two elongated strips may fit more closely and robustly to the driver box.

In some embodiments, the track has a hook structure corresponding to the vertical bar to fix the vertical bar. Specifically, there may be inverse hooks or other hooks so that when the two elongated strips enters predetermined positions of the tracks, the two elongated strips are locked by the inverse hooks or other hook structures.

In some embodiments, the driver circuit is placed in a bottom portion of the driver box close to the back cover of the main housing.

In such design, the driver circuit is placed close to the back cover, which on the other side is disposed with the light source plate. Such design may help decrease the distance between the driver circuit and the light source plate. For example, the back cover may be reserved with holes for interconnecting wires to passing through for electrically connecting the driver circuit and light source plate.

As mentioned above, the driver circuit may not occupy whole space of the containing space of the driver box. The rest space may be used for heat dissipation and for safety enhancement, e.g. in a fire accident.

In some other embodiments, the driver circuit is kept a predetermined height away from a bottom portion of the driver box with respect to the back cover of the main housing.

In such design, the driver circuit is kept with a certain distance from the bottom side of the driver box and thus also away from the back cover which may be attached with light source plate.

With such design, the heat of the light source plate may not damage the components of the driver circuit, increasing heat dissipation and safety of the downlight apparatus.

In some embodiments, the predetermined height of is larger than 20% of a total height of the driver box. In other words, a height of 20% or more of the total height of the driver box is kept to keep the driver circuit from the bottom of the driver box.

In some other embodiments, the driver circuit is placed in a top portion of the driver box.

In such design, the driver circuit is kept as far as possible away from the light source plate. Depending on different design needs, such as the heat of the light source plate, the three design types may be selected by designers for meeting different needs.

In other words, the same structures, by reserving certain space of the driver box and by adjusting the position of the driver circuit in the driver box, may be used in multiple standards of similar downlight apparatuses, and thus further decrease manufacturing and storage cost.

In some embodiments, the downlight apparatus may also include a diffusion cover covering the light opening.

In some embodiments, the thickness of the container of the main housing may be smaller than a height of the driver box. In other words, such design is particularly helpful for thin downlight design. Sometimes, such downlight apparatuses may be called panel light apparatuses.

In some embodiments, the driver box is detachable from the back cover of the main housing. Such design is helpful on assembly and also helpful on modular manufacturing.

In some embodiments, the back cover of the main housing may have at least one through hole for an interconnecting wire to pass though for electrically connecting the light source plate to the driver circuit.

The interconnecting wire may have a plugging structure so as no welding is necessary while connecting the driver box to the light source plate.

In some embodiments, the interconnecting wire is attached to the second positioning device entering the driver box to connect to the driver circuit.

In such design, the second positioning device may enter the driver box and carry the interconnecting wire at the same time.

In some embodiments, the driver box has a top cover manually openable for connecting a wire to the driver circuit. The top cover is open for wiring the driver circuit to outside power source and/or to the light source plate.

In some embodiments, the driver circuit is attached to the top cover. In such design, the driver circuit is kept away from the back cover and also convenient to be installed.

### BRIEF DESCRIPTION OF DRAWINGS

FIG. 1 an exploded view of a downlight apparatus embodiment.

FIG. 2 an assembled view of the embodiment of FIG. 1.

FIG. 3 an example of a second positioning device.

FIG. 4 a view of inner structure of a driver box.

FIG. 5 illustrates an elastic wing.

### DETAILED DESCRIPTION

In some embodiments, a downlight apparatus is designed to be fixed to an installation cavity of a ceiling.

The downlight apparatus includes a main housing, a light source plate, two elastic wings, a driver circuit and a driver box.

The main housing has a back cover, a container and a light opening. The light source plate may be mounted with multiple LED chips. The light source plate is attached to a bottom side of the back cover of the main housing.

The light may be emitted directly toward the light opening. Alternatively, a light guide may be used for guiding LED light sources to the light opening via the light guide.

The light source plate may be a circulate plate shape directly attached to a bottom side of the back cover. Alternatively, the light source plate may be a circular belt surrounding a light guide as mentioned above.

In some embodiments, the light opening may be covered by a lens or a diffusion cover.

In different areas, the ceiling may be opened or reserved with an installation cavity, e.g. with a reserved hole in a ceiling or an installation box disposed in the ceiling.

To fix the downlight apparatus to the ceiling, the two or more elastic wings have first ends fixed to the main housing while second ends for engaging the installation cavity. Specifically, the elastic wing may be made of a spring that may be deformed, reshaped or rotated elastically so as to enter the installation cavity. After the downlight apparatus enters the installation cavity, the elastic wings may be expanded back to original shape to hold the downlight apparatus staying in the installation cavity, instead of falling down.

The driver circuit is used for converting an external power source to a driving current supplying to the light source plate for generating light transmitting outside the light opening. A wireless circuit and corresponding processor circuit for connecting with an external device like a mobile phone may also be disposed in the driver circuit for transmitting commands and/or transmitting status of the downlight apparatus.

The driver box may be made of metal material. The driver box contains the driver circuit. The metal material may be used for heat dissipation and safety, e.g. to prevent further damage during fire accident.

The driver box may have at least one first positioning device. The driver box has a containing space. The driver circuit may occupy less than 70% of the containing space. Specifically, there is a certain amount of space reserved in the driver box, even the driver circuit is installed in the driver box.

Such design may help heat dissipation, and may increase safety of the downlight apparatus. Some reservation holes may be used for connecting wires connecting to an external power source or the light source plate of the downlight apparatus.

There may also be at least one second positioning device disposed on a top side of the back cover. The second positioning device may be a part component of the back cover, e.g. formed at the same shaping process while manufacturing the back cover or as a separate component fixed to the back cover. The second positioning device is corresponding to the first positioning device. Specifically, if there are two first positioning devices, there are two corresponding second positioning devices. The first positioning device is positioned, e.g. aligned or confined by, and attached to the second positioning device for fixing the driver box to the back cover.

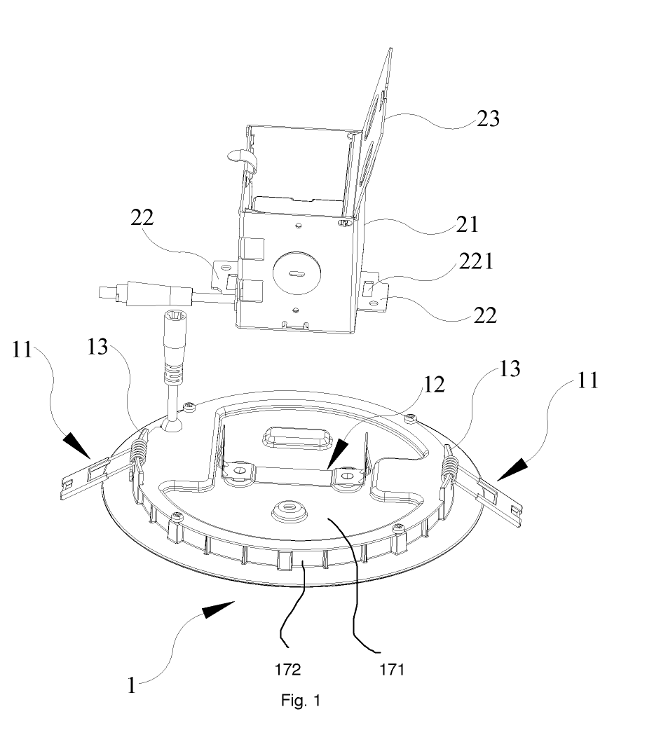

Please refer to FIG. 1. FIG. 1 an exploded view of a downlight apparatus.

In FIG. 1, the downlight apparatus has a driver box 21 and main housing 1.

The driver box 21 has a top cover 23 that may be open. The driver box 21 has two positioning holes 221 defined by two first positioning devices on two opposite sides.

There are two second positioning devices 12, the upwardly protruding strips, corresponding to the first positioning devices.

Two elastic wings 11 are fixed to axial structures of the main housing so as to fix the downlight apparatus to an installation cavity.

The main housing has a back cover 171. The second positioning devices 12 are placed on the back cover 171.

The main housing 1 also has a container 172 and a light opening (not shown).

A light source board (not shown) is disposed and enclosed in the container of the main housing 1. Light is guided and escaped outside the downlight apparatus from the light opening, which is at the opposite side of the back cover 171.

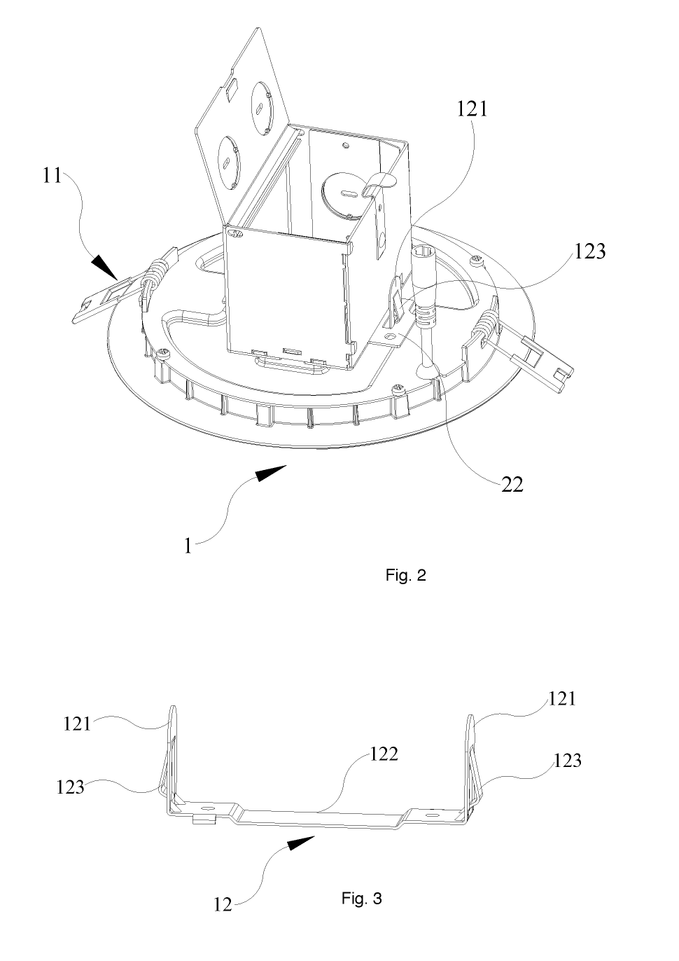

Please refer to FIG. 2. FIG. 2 is an assembled view of the embodiment of FIG. 1.

In FIG. 2, The second positioning device 121 has an inverse hook 123 corresponding to a hook structure to be locked to the driver box.

Please refer to FIG. 3. FIG. 3 is an example of a second positioning device.

In FIG. 3, the second positioning devices 12, 121 are connected by a horizontal part 122, forming a U shape structure. The embodiment may be made by bending two opposite ends of an elongated strip.

The inverse hook 123 may be made by stamping the elongated strip.

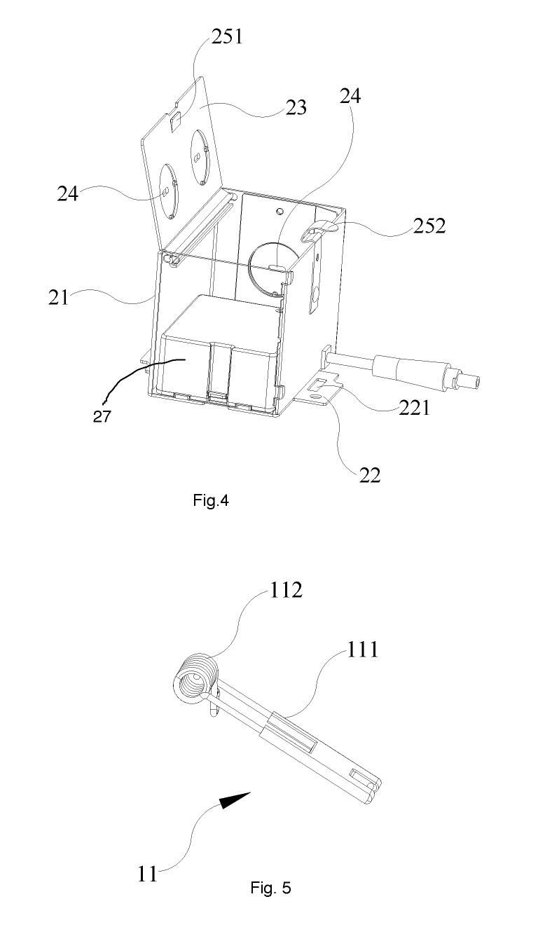

Please refer to FIG. 4. FIG. 4 a view of inner structure of a driver box.

In FIG. 4, the driver box 21 has a lock 252 corresponding to a lock hole 251.

There are wire holes 24 for connecting to external wires connecting to the light source plate or an external power source.

The driver circuit 27 is placed at one of several positions in the driver box 21, as mentioned above and below.

Please refer to FIG. 5. FIG. 5 illustrates an elastic wing.

In FIG. 5, the elastic wing 11 has a lever 111 and a spring so as to deform, entering a installation cavity of a ceiling, and then recovered to hold the downlight apparatus in the installation cavity.

In some embodiments, there are two first positioning devices arranged on two opposite sides of the driver box. Furthermore, the two first positioning devices may respectively have two positioning holes. There are two second positioning devices as two vertical bars passing through the two positioning holes respectively.

In such case, two vertical bars extends from the back cover upwardly facing to corresponding positioning holes. The driver box is plugged and attached to the back cover of the main housing.

With such alignment, it is easy to assembly the downlight apparatus. Furthermore, it is also convenient to connect related wires for making the downlight apparatus working normally.

In some embodiments, the two vertical bars engage lateral surfaces of the driver box after passing through the two positioning holes. In such design, the vertical bars may help transmit heat for enhance overall heat dissipation of the downlight apparatus.

In some embodiments, the two vertical bars may carry heat of the light source plate to the lateral surfaces of the driver box.

The two vertical bars may also increase rigidity and structure strength of the downlight apparatus. For example, the main housing may be made of plastic, and the two vertical bars grab the metal driver box. The driver box enhance the structure strength of the plastic main housing.

In some embodiments, the two vertical bars are two elongated strips. In some embodiments, the front end of the two elongated strips may be rounded or processed with a chamfer for preventing hurting people and for enhancing assembly of the downlight apparatus.

In some embodiments, the two elongated strips are connected by a horizontal part, the horizontal part is fixed on the top side of the back cover. For example, the two elongated strips and the horizontal part together form a U shape structure facing upwardly. The length of the horizontal part corresponds to a width of the driver box so that the driver box may be fit between the inner shape of the two elongated strips and the horizontal part.

In some embodiments, the two elongated strips and the horizontal part are different parts of an uni-body metal component. Specifically, the two elongated strips and the horizontal part are made in the same process, e.g. by bending two opposite ends with 90 degrees facing upwardly by applying the force to an elongated metal strip.

In some embodiments, the driver box further has two tracks disposed on the lateral surfaces for inserting the two vertical bars. Specifically, in addition to the two positioning holes, the driver box further has two tracks corresponding to the two elongated strips passing through the positioning holes. With such track, the two elongated strips may fit more closely and robustly to the driver box.

In some embodiments, the track has a hook structure corresponding to the vertical bar to fix the vertical bar. Specifically, there may be inverse hooks or other hooks so that when the two elongated strips enters predetermined positions of the tracks, the two elongated strips are locked by the inverse hooks or other hook structures.

In some embodiments, the driver circuit is placed in a bottom portion of the driver box close to the back cover of the main housing.

In such design, the driver circuit is placed close to the back cover, which on the other side is disposed with the light source plate. Such design may help decrease the distance between the driver circuit and the light source plate. For example, the back cover may be reserved with holes for interconnecting wires to passing through for electrically connecting the driver circuit and light source plate.

As mentioned above, the driver circuit may not occupy whole space of the containing space of the driver box. The rest space may be used for heat dissipation and for safety enhancement, e.g. in a fire accident.

In some other embodiments, the driver circuit is kept a predetermined height away from a bottom portion of the driver box with respect to the back cover of the main housing.

In such design, the driver circuit is kept with a certain distance from the bottom side of the driver box and thus also away from the back cover which may be attached with light source plate.

With such design, the heat of the light source plate may not damage the components of the driver circuit, increasing heat dissipation and safety of the downlight apparatus.

In some embodiments, the predetermined height of is larger than 20% of a total height of the driver box. In other words, a height of 20% or more of the total height of the driver box is kept to keep the driver circuit from the bottom of the driver box.

In some other embodiments, the driver circuit is placed in a top portion of the driver box.

In such design, the driver circuit is kept as far as possible away from the light source plate. Depending on different design needs, such as the heat of the light source plate, the three design types may be selected by designers for meeting different needs.

In other words, the same structures, by reserving certain space of the driver box and by adjusting the position of the driver circuit in the driver box, may be used in multiple standards of similar downlight apparatuses, and thus further decrease manufacturing and storage cost.

In some embodiments, the downlight apparatus may also include a diffusion cover covering the light opening.

In some embodiments, the thickness of the container of the main housing may be smaller than a height of the driver box. In other words, such design is particularly helpful for thin downlight design. Sometimes, such downlight apparatuses may be called panel light apparatuses.

In some embodiments, the driver box is detachable from the back cover of the main housing. Such design is helpful on assembly and also helpful on modular manufacturing.

In some embodiments, the back cover of the main housing may have at least one through hole for an interconnecting wire to pass though for electrically connecting the light source plate to the driver circuit.

The interconnecting wire may have a plugging structure so as no welding is necessary while connecting the driver box to the light source plate.

In some embodiments, the interconnecting wire is attached to the second positioning device entering the driver box to connect to the driver circuit.

In such design, the second positioning device may enter the driver box and carry the interconnecting wire at the same time.

In some embodiments, the driver box has a top cover manually openable for connecting a wire to the driver circuit. The top cover is open for wiring the driver circuit to outside power source and/or to the light source plate.

In some embodiments, the driver circuit is attached to the top cover. In such design, the driver circuit is kept away from the back cover and also convenient to be installed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A downlight apparatus for fixing to an installation cavity of a ceiling, comprising:
a main housing having a back cover, a container and an light opening;
a light source plate enclosed by the container;
two elastic wings, the elastic wing having a first end fixed to the main housing and a second end for engaging the installation cavity for fixing the downlight apparatus to the ceiling;
a driver circuit for converting an external power source to a driving current supplying to the light source plate for generating light transmitting outside the light opening;
a driver box made of metal material, the driver box containing the driver circuit, the driver box having at least one first positioning device, the driver box having a containing space, the driver circuit occupying less than 70% of the containing space; and
at least one second positioning device disposed on a top side of the back cover, the second positioning device corresponding to the first positioning device, the first positioning device being positioned and attached to the second positioning device for fixing the driver box to the back cover.

2. The downlight apparatus of claim 1, wherein there are two first positioning devices arranged on two opposite sides of the driver box, the two first positioning devices respectively having two positioning holes, and there are two second positioning devices as two vertical bars passing through the two positioning holes respectively.

3. The downlight apparatus of claim 2, wherein the two vertical bars engaging lateral surfaces of the driver box after passing through the two positioning holes.

4. The downlight apparatus of claim 3, wherein the two vertical bars carrying heat of the light source plate to the lateral surfaces of the driver box.

5. The downlight apparatus of claim 3, wherein the two vertical bars are two elongated strips.

6. The downlight apparatus of claim 5, wherein the two elongated strips are connected by a horizontal part, the horizontal part is fixed on the top side of the back cover.

7. The downlight apparatus of claim 6, wherein the two elongated strips and the horizontal part are different parts of an uni-body metal component.

8. The downlight apparatus of claim 2, wherein the driver box further has two tracks disposed on the lateral surfaces for inserting the two vertical bars.

9. The downlight apparatus of claim 8, wherein the track has a hook structure corresponding to the vertical bar to fix the vertical bar.

10. The downlight apparatus of claim 1, wherein the driver circuit is placed in a bottom portion of the driver box close to the back cover of the main housing.

11. The downlight apparatus of claim 1, wherein the driver circuit is kept a predetermined height away from a bottom portion of the driver box with respect to the back cover of the main housing.

12. The downlight apparatus of claim 11, wherein the predetermined height of is larger than 20% of a total height of the driver box.

13. The downlight apparatus of claim 1, wherein the driver circuit is placed in a top portion of the driver box.

14. The downlight apparatus of claim 1, further comprising a diffusion cover covering the light opening.

15. The downlight apparatus of claim 1, wherein a thickness of the container of the main housing is smaller than a height of the driver box.

16. The downlight apparatus of claim 1, wherein the driver box is detachable from the back cover of the main housing.

17. The downlight apparatus of claim 1, wherein the back cover of the main housing having at least one through hole for an interconnecting wire to pass though for electrically connecting the light source plate to the driver circuit.

18. The downlight apparatus of claim 17, wherein the interconnecting wire is attached to the second positioning device entering the driver box to connect to the driver circuit.

19. The downlight apparatus of claim 1, wherein the driver box has a top cover manually openable for connecting a wire to the driver circuit.

20. The downlight apparatus of claim 19, wherein the driver circuit is attached to the top cover.
